(19) United States
(12) Patent Application Publication
(10) Pub. No.: US 2023/0201055 A1
(43) Pub. Date: Jun. 29, 2023

(54) REMOVABLE ELECTRONIC PROPULSION SYSTEM FOR A ROLLING OBJECT WITH AN AUTOMATIC DIRECTIONAL BLOCKING MEANS

(71) Applicant: IFP Energies nouvelles, RUEIL-MALMAISON (FR)

(72) Inventors: Stephane VENTURI, RUEIL-MALMAISON CEDEX (FR); Bertrand LECOINTE, RUEIL-MALMAISON CEDEX (FR)

(21) Appl. No.: 17/927,077

(22) PCT Filed: May 5, 2021
(86) PCT No.: PCT/EP2021/061868

§ 371 Date: Nov. 22, 2022

(30) Foreign Application Priority Data
May 29, 2020 (FR) FR2005677

(51) Int. Cl. A61G 7/08; B62B 3/06; B62B 3/12; B62B 5/00

(52) U.S. Cl. CPC A61G 7/08; B62B 3/06; B62B 3/12; B62B 5/0043; B62B 5/0079; B62B 2202/30; B62B 2206/02; B62B 2301/0463

(57) ABSTRACT

The present invention relates to a removable electric propulsion system (1) for a rolling object. Propulsion system (1) comprises a frame (2) with a driven wheel (3) and at least one non-driven wheel (4). Among these non-driven wheels (4), one at least is an orientable off-centered wheel. System (1) also comprises means for coupling at least one wheel of the rolling object. System (1) also comprises an automatic directional locking device for locking the rotation about a vertical axis of at least one of the orientable off-centered wheels in a predetermined direction.

The invention also relates to a coupled assembly comprising a propulsion system (1) and a rolling object.

The invention further relates to a method for directional and automatic locking of at least one orientable off-centered wheel of a propulsion system.

### FIELD OF THE INVENTION

The invention relates to the field of transport of rolling objects, in particular rolling beds, hospital beds for example.

Moving heavy rolling loads can lead to difficulties for users, in particular if this action is repeated, such as musculoskeletal disorders.

### BACKGROUND OF THE INVENTION

In order to make the motion of heavy rolling loads easier and more ergonomic, it has been considered to equip these heavy loads with electric machines. For example, a first idea has consisted in providing each hospital bed with an electric wheel drive system. Such a solution is expensive because it requires changing or modifying all the beds, which hospitals cannot afford. Furthermore, the drive system and its battery increase the weight of the bed. Therefore, when the battery is discharged, the effort required to move the bed is greater.

Similarly, in the field of logistics or trade, it has been envisaged to make all trolleys electric. Again, such a solution is expensive.

One alternative is to provide a removable propulsion system for rolling objects. Several technical solutions have been considered.

For example, Patent Application WO-01/85,086 describes a motorized propulsion system for a bed. The propulsion system is configured for coupling to one or more points of the bed. Due to the coupling means provided for this propulsion system, the system cannot be universal and suitable for different rolling objects. Indeed, it cannot be coupled to a rolling object not provided with a coupling part. In addition, for this propulsion system, all the wheels of the rolling object remain in contact with the floor. Therefore, the orientation of the coupled assembly (propulsion system and bed) is more complicated, the frictional forces are high and the motorized wheel requires more power. Besides, as all the wheels of the rolling object remain in contact with the floor, displacement of the assembly is difficult, in particular in reduced spaces.

Patent Application WO-2012/171,079 describes a second propulsion system for a hospital bed. The propulsion system is configured to lift two wheels of the bed. However, the wheel gripping mechanism is complex and bulky: the lateral dimension (direction parallel to the axis of the motorized wheels) is great (greater than the width of the bed wheels) and it can exceed the lateral dimensions of the bed, which may be inconvenient for moving the bed, in particular in a reduced space such as a hospital corridor or lift.

Patent Application WO-2013/156,030 describes a third propulsion system for a hospital bed. The propulsion system is configured to lift two wheels of the bed. However, the system has great lateral (direction parallel to the axis of the motorized wheels) and longitudinal (direction perpendicular to the axis of the wheels) dimensions: the rear platform protrudes from the bed and the distance between the non-motorized wheels can exceed the dimensions of the bed, which may be inconvenient for moving the bed, in particular in a reduced space such as a hospital corridor or lift.

In order to solve the problems of the prior art, the goal of the invention is to provide a system that can be adapted to various rolling objects and provide high maneuverability, notably in limited spaces.

The present invention therefore relates to a removable electric propulsion system intended to be coupled to a rolling object. The propulsion system comprises a frame provided with at least one wheel driven by an electric machine, and at least one non-driven wheel. At least one of the non-driven wheels is an orientable off-centered wheel. Furthermore, the system, preferably the frame, comprises means for coupling the propulsion system to the rolling object, the coupling means comprising means for gripping and lifting at least one wheel of the rolling object. Furthermore, the system comprises an automatic directional locking device for automatically locking, in a predetermined direction, the rotation about a vertical axis of at least one orientable off-centered wheel.

### SUMMARY OF THE INVENTION

The invention relates to a removable electric propulsion system for a rolling object, said propulsion system comprising a frame provided with at least one wheel driven by an electric machine, and at least one non-driven wheel, at least one of said at least one non-driven wheel comprising an orientable off-centered wheel, said electric propulsion system comprising means for coupling said electric propulsion system to said rolling object, said coupling means comprising means for gripping and lifting at least one wheel of said rolling object. Furthermore, the electric propulsion system comprises an automatic directional locking device for locking, in a predetermined direction, the rotation about a vertical axis of at least one of said orientable off-centered wheels, preferably the predetermined direction being along the longitudinal axis of the frame, the longitudinal axis (x) being defined by the principal direction of displacement of the frame.

Advantageously, the automatic directional locking device locks at least one of said lockable orientable off-centered wheels in the direction of the driven wheel.

According to an alternative of the invention, the automatic directional locking device locks at least one of said lockable orientable off-centered wheels in the opposite direction to the driven wheel.

Preferably, the electric propulsion system comprises at least two lockable orientable off-centered wheels, the automatic directional locking device locking said at least two lockable orientable off-centered wheels in said predetermined direction.

Preferably, said coupling means comprise means for orienting at least one wheel of said rolling object in a direction forming a non-zero angle with the longitudinal direction of said frame of said electric propulsion system, preferably said coupling means comprise means for orienting at least one wheel of said rolling object in a direction substantially perpendicular to the longitudinal direction of said frame of said electric propulsion system.

According to an advantageous configuration of the invention, said automatic directional locking device comprises at least two connecting elements configured to cooperate with one another so as to provide directional locking, a first connecting element being positioned on at least one of said lockable orientable off-centered wheels and a second connecting element being positioned on said frame, preferably one of said two connecting elements is a male element and the other of said two connecting elements is a female element, the engagement of said male element in said female element providing said directional locking.

Advantageously, the automatic directional locking device comprises at least two female elements and/or at least two male elements.

According to an implementation of the invention, said male elements comprise at least one pin, one finger and/or one key.

According to an embodiment of the invention, said female elements comprise cylindrical holes, oblong holes and/or grooves.

Preferably, said automatic directional locking device comprises an unlocking control means, said unlocking control means preferably comprising an electromagnet, the unlocking control means being preferably manual.

Advantageously, the automatic directional locking device locks at least one of said lockable orientable off-centered wheels through the motion opposite to said predetermined direction of the electric propulsion system and/or of the rolling object.

According to an embodiment of the invention, the frame comprises at least two parts connected by a transverse-axis pivot connection and/or by a longitudinal slideway, said automatic directional locking device being configured to lock at least one of said lockable orientable off-centered wheels through the relative motion of said two parts.

According to a variant of the invention, at least one of said two parts comprises at least one arm of variable length, at least one of said lockable orientable off-centered wheels being positioned substantially at one end of said arm of variable length.

Preferably, said two parts are connected by an articulated structure in the central part of the frame, between at least one of the driven wheels and at least one of said orientable off-centered wheels.

The invention also relates to a coupled assembly comprising a rolling object and an electric propulsion system as described above, said rolling object being coupled to said electric propulsion system by said coupling means.

The invention further relates to a method for directional locking of at least one of said lockable orientable off-centered wheels of a removable electric propulsion system as described above, wherein the rolling object and/or the electric propulsion system is moved so as to position at least one of said lockable orientable off-centered wheels in said predetermined position, and at least one of said lockable orientable off-centered wheels is directionally locked in an automatic manner.

Preferably, a rotational and/or translational motion of at least one part of the frame in relation to the other part of the frame is achieved, so as to position at least one of said lockable orientable off-centered wheels in said predetermined position, and at least one of said lockable orientable off-centered wheels is directionally locked in an automatic manner.

Advantageously, the length of said arm of variable length is increased to its maximum position, then the length of said arm of variable length is decreased so as to position at least one of said lockable orientable off-centered wheels in the opposite direction to driven wheel (3), and at least one of said lockable orientable off-centered wheels is automatically locked in said opposite direction to the driven wheel.

### BRIEF DESCRIPTION OF THE FIGURES

Other features and advantages of the system and of the method according to the invention will be clear from reading the description hereafter of embodiments given by way of non-limitative example, with reference to the accompanying figures wherein:

FIG. 1 is a top view of an electric propulsion system according to an embodiment of the invention,

FIG. 2 is a side view of an electric propulsion system according to a first variant embodiment of the invention,

FIG. 3 is a side view of an electric propulsion system according to a second variant embodiment of the invention,

FIG. 4 is a top view of an electric propulsion system according to an embodiment coupled to a rolling object, according to the invention,

FIG. 5 shows a first method for directional locking of at least one orientable off-centered wheel of a propulsion system according to the invention,

FIG. 6a shows a first embodiment, in unlocked mode, of a directional locking device of a propulsion system according to the invention,

FIG. 6b shows the directional locking device of FIG. 6a in locked mode,

FIG. 7 shows the misalignment when the wheel is directionally locked in the opposite direction to the driven wheel,

FIG. 8 shows a directional locking method for at least one orientable off-centered wheel of a propulsion system according to the invention with a foldable frame,

FIG. 9a shows a first embodiment of a propulsion system according to the invention, coupled to the rolling object, with a part of the extensible frame in folded position, and

FIG. 9b shows a first embodiment of a propulsion system according to the invention, coupled to the rolling object, with a part of the extensible frame in unfolded position.

### DETAILED DESCRIPTION OF THE INVENTION

The invention relates to a removable electric propulsion system for a rolling object. An electric propulsion system is understood to be a removable system for assisting the motion of the rolling object in order to limit the forces required for moving the rolling object. This electric propulsion system comprises at least one electric machine for driving it. A rolling object is an object comprising at least two wheels in order to move it.

The rolling object can have any form, it can notably be a rolling bed, in particular such as those used in hospitals, a wheelchair, a trolley, such as those used for logistics, hospital logistics or commercial logistics (such as a shopping trolley) for example, any rolling furniture. Such a rolling object comprises at least two wheels, preferably three or four. Advantageously, at least one wheel, preferably two wheels of the rolling object are idle wheels, in other words, off-centered wheels orientable around a vertical axis. The rolling object is preferably non-motorized.

The electric propulsion system according to the invention comprises:
a frame provided with at least one motorized wheel, i.e. a wheel driven by an electric machine, and at least one non-motorized wheel, i.e. not driven by an electric machine. The frame preferably comprises at least two non-motorized wheels,
means for coupling the propulsion system to a rolling object, the coupling means comprise means for gripping and lifting at least one wheel of the rolling object, preferably two wheels of the rolling object; in other words, the coupling means are configured to grip (grab) and lift at least one wheel of the rolling object.

Among the non-driven wheels, one at least is an orientable off-centered wheel, and the system preferably has at least two orientable off-centered wheels.

Orientable off-centered wheels are understood to be off-centered idle wheels orientable about a vertical axis. In other words, these wheels can pivot relative to the frame around a vertical orientation axis, and the rotation axis of the wheel is off-centered (non-concurrent) relative to the vertical orientation axis. Thus, a motion applied onto the frame tends to orient the wheel in the opposite direction to the displacement resulting from the motion applied onto the frame. The wheels are thus automatically oriented, thus facilitating the maneuverability of the system.

Preferably, the electric propulsion system can have a handlebar allowing the electric propulsion system to be handled, moved and oriented by a user.

Coupling the rolling object to the propulsion system is achieved by means of at least one wheel of the rolling object, preferably at least one idle wheel of the rolling object. The rolling object therefore does not need to be adapted for the electric propulsion system, which makes the electric propulsion system universal for various rolling objects. Preferably, coupling the rolling object to the propulsion system can be achieved by means of two wheels of the rolling object, which simplifies the coupling method and the associated coupling device.

Furthermore, the system comprises an automatic directional locking device for automatically locking, in a predetermined direction, the rotation about the vertical axis of at least one orientable off-centered wheel. The orientable off-centered wheels that can be locked by a directional locking device are referred to as “lockable orientable off-centered wheels”. In other words, at least one of the initially idle wheels (i.e. free to align in any direction) can be locked in a predetermined direction about the vertical axis. The automatic directional locking device does not prevent rotation of the lockable orientable off-centered wheels about their rotation axis (which is horizontal). This automatic directional locking device is therefore not a braking means. The automatic directional locking device prevents the orientable off-centered wheel from self-orienting. It is thus locked in a given direction, in the longitudinal direction for example. The automatic directional locking device makes it possible to lock the wheel automatically, without user intervention when the wheel is in the desired direction.

The direction of the orientable off-centered wheel is understood to be the direction given by the perpendicular direction to the off-centered vertical axis of the orientable off-centered wheel passing through the centre of the orientable off-centered wheel, this direction going from the off-centered vertical axis of the orientable off-centered wheel to the centre of the orientable off-centered wheel.

This automatic directional locking device allows the maneuverability of the propulsion system to be improved, notably when it is coupled to the rolling object. Indeed, by locking at least one orientable off-centered wheel in the predetermined direction, a so-called “5^{th} wheel” effect is obtained. This effect consists, through at least one directionally locked wheel, in creating a pivot point, this pivot point being substantially around this locked wheel if the system has a single locked orientable off-centered wheel. It is thus possible to pivot the coupled system around this pivot point. When two wheels are directionally locked, for example two orientable off-centered wheels located at one longitudinal end of the frame distant from the other longitudinal end of the frame that supports at least one driven wheel, the pivot point generated by the 5^{th} wheel effect is located in the middle of the two lockable orientable off-centered wheels.

In any case, the generation of this pivot point improves the maneuverability of the coupled system, notably in a reduced space such as a lift or a hospital corridor.

In addition, the directional locking device being automatic, directional locking is achieved as soon as the lockable orientable off-centered wheel is in the predetermined position. The fact that the directional locking device is automatic allows directional locking operations to be simplified for the user. Furthermore, automatic directional locking allows directional locking to be achieved always in the predetermined direction, the longitudinal direction for example.

For example, this automatic directional locking can be achieved by means of an armed system ready to engage as soon as the lockable orientable off-centered wheel reaches the predetermined position. The system can be armed for example by means of a spring or any similar mechanism.

Preferably, the predetermined direction can be along the longitudinal axis of the frame, and the longitudinal axis can be defined as the axis connecting at least one driven wheel to at least one orientable off-centered wheel, preferably to at least one lockable orientable off-centered wheel, thus corresponding to the principal direction of displacement of the electric propulsion system. For example, a driven wheel is located at one end of the frame and two orientable off-centered wheels (of which at least one and preferably both are lockable orientable off-centered wheels) are positioned at the other end of the frame. The longitudinal axis is then defined as the axis passing through the driven wheel and passing through the middle of the two orientable off-centered wheels. Thus, the predetermined position is in the longitudinal direction (from the driven wheel to the orientable off-centered wheels along the longitudinal axis or vice versa), which is preferably the longitudinal direction of the rolling object, the bed for example, so as to facilitate the displacement and maneuverability of the rolling object.

In the rest of the description, the terms “longitudinal”, “transverse”, “horizontal” and “vertical” determine the axes and/or directions of the system when it rests on a flat and level floor (i.e. a floor with no slope, in other words, there is no difference in altitude on the floor) and is in an operative position.

The longitudinal direction corresponds to the principal direction of displacement of the electric propulsion system.

The transverse direction is orthogonal to the longitudinal direction of the system in the horizontal plane.

The vertical direction is orthogonal to the horizontal plane of the system.

According to a configuration of the invention, the automatic directional locking device can lock at least one off-centered wheel orientable in the direction of the driven wheel. By off-centered wheel orientable in the direction of the driven wheel, it is meant that, starting from its off-centered vertical axis, the orientable off-centered wheel is oriented in the predetermined direction and in the direction of the side on which the driven wheel is positioned. In other words, in side view, the centre of the orientable off-centered wheel lies between the vertical axis of this wheel and the centre of the driven wheel. Therefore, a simple forward motion of the propulsion system orients the orientable off-centered wheels in the direction of the driven wheel. When the system comprises at least one extensible arm, an elongation of the extensible arm enables orientation of the orientable off-centered wheels in the direction of the driven wheel. Thus, the automatic directional locking device can lock the orientable off-centered wheel directionally through a simple forward motion of the system. Directional locking of the orientable off-centered wheels is automatic and therefore easily performed.

According to a variant of the invention, the system can comprise a motor for orienting the orientable off-centered wheel in the direction of the driven wheel and thus lock the orientable off-centered wheel in this direction by means of the automatic directional locking device.

According to a variant of the invention, the automatic directional locking device can lock at least one off-centered wheel orientable in the opposite direction to the driven wheel. By off-centered wheel orientable in the opposite direction to the driven wheel, it is meant that, starting from its vertical axis, the orientable off-centered wheel is oriented in the predetermined direction and in the opposite direction to the side on which the driven wheel is positioned. In other words, in side view, the centre of the orientable off-centered wheel lies between the vertical axis of this wheel and the centre of the driven wheel. In other words, in side view, the vertical axis of the orientable off-centered wheel is positioned between the centre of the driven wheel and the centre of the lockable orientable off-centered wheel. This directional locking in the opposite direction to the driven wheel can for example be obtained through a backward motion of the propulsion system or by shortening the extensible arm when the system comprises such an arm. According to a variant, a motor can also allow to orient the orientable off-centered wheels in the opposite direction to the driven wheel. This configuration is advantageous because, by positioning the orientable off-centered wheel in the opposite direction to the driven wheel, the distance between the driven wheel and the locked orientable off-centered wheel is maximum since the axis of the orientable off-centered wheel is positioned between the centre of the orientable off-centered wheel and the centre of the driven wheel. Thus, the “5^{th} wheel” effect is improved, as is the maneuverability of the system. This position of the locked orientable off-centered wheel allows to be as close as possible to the centre of the rolling object and therefore to provide improved maneuverability.

According to an advantageous embodiment, the propulsion system can comprise at least two lockable orientable off-centered wheels, the automatic directional locking device locking the at least two lockable orientable off-centered wheels in the predetermined direction. Thus, the frame can for example comprise a driven wheel at one longitudinal end of the frame and two lockable orientable off-centered wheels at the other longitudinal end of the frame, and the axes of the orientable off-centered wheels can be preferably coaxial when directionally locked, so as to improve the system maneuverability. The pivot point generated by locking the lockable orientable off-centered wheels is positioned in the middle of the centres of these lockable orientable off-centered wheels.

Preferably, the coupling means can comprise means for orienting at least one wheel of the rolling object in a direction forming a non-zero angle with the longitudinal direction of the frame of the propulsion system and, preferably, the coupling means can comprise means for orienting at least one wheel of the rolling object in a direction substantially perpendicular to the longitudinal direction of the frame of said propulsion system. Therefore, the rolling object is immobilized in a simple manner with the propulsion system; in other words, no relative motion between the rolling object and the propulsion system is possible.

According to an implementation of the system, the automatic directional locking device can comprise at least two connecting elements configured to cooperate with one another so as to provide directional locking, a first connecting element being positioned on at least one lockable orientable off-centered wheel and a second connecting element being positioned on the frame. When they cooperate, the two connecting elements lock the lockable orientable off-centered wheel directionally. Thus, the orientable off-centered wheel can no longer freely rotate about its vertical axis. It is no longer self-orientable.

One of the two connecting elements can notably be armed, i.e. it is configured to automatically cooperate with the other connecting element. It may therefore comprise a spring or any similar system.

Preferably, one of the connecting elements can be a male element and the other connecting element is a female element, the engagement of the male element in the female element ensuring directional locking. Thus, directional locking can be achieved in a simple manner, and the male element can be armed so as to be automatically inserted in the female element when the female element is in the predetermined direction.

Preferably, the automatic directional locking device can comprise at least two female elements and/or two male elements. When the directional locking device comprises one male element and two female elements, or when it comprises two male elements and one female element, it is possible to directionally lock an orientable off-centered wheel in two different positions, for example the orientable off-centered wheel can be locked in the predetermined direction towards the driven wheel and the opposite direction to the driven wheel, which makes it easier to use the system and the orientable off-centered wheel directional locking possibilities.

When the directional locking device comprises two male elements and two female elements, the number of predetermined directions can be further increased, which allows the directional locking possibilities to be further increased accordingly. This type of locking device also enables directional locking of two orientable off-centered wheels simultaneously.

According to a variant of the invention, the male elements (at least one male element) can comprise at least one pin, one finger or one key. Thus, they can be readily inserted in an orifice, whether a cylindrical hole, an oblong hole or a groove.

According to an implementation of the invention, the female elements (at least one female element) can comprise cylindrical holes, oblong holes and/or grooves. They can therefore readily cooperate with the aforementioned male elements (pin, finger or key).

Advantageously, the automatic directional locking device can comprise an unlocking control device. Indeed, the unlocking control device can be used to unlock the automatic directional locking device or to prevent directional locking of the orientable off-centered wheels, which is automatic under normal operating conditions, when it is not desired to directionally lock the orientable off-centered wheels. Freewheeling (idle wheeling) can be maintained by preventing automatic directional locking of the wheels by means of the unlocking control device, which is particularly advantageous for example for laterally (transversely) pushing the rolling object (the bed for example) coupled to the electric propulsion system so as to position it along a wall.

Preventing inadvertent directional locking of the orientable off-centered wheels is also advantageous during coupling phases, when the arms carrying the gripping and lifting means are moved away or closer to one another, so as to facilitate gripping and lifting of the rolling object wheels.

Preventing inadvertent directional locking of the orientable off-centered wheels can also be useful for maintaining the original behaviour of the rolling object (when the stretcher bearer is used to handling a hospital bed for example) by directionally locking the wheels of the rolling object still on the ground instead of locking the lockable orientable off-centered wheels of the propulsion system.

Preferably, the unlocking control device can comprise an electromagnet. Thus, unlocking control can be readily activated, and the unlocking control device is light and space-saving. The unlocking control device can preferably be manual, i.e. manually operated, for example by means of a pushbutton, a lever or equivalent.

According to an advantageous embodiment of the invention, the automatic directional locking device locks at least one lockable orientable off-centered wheel through the opposite motion to the predetermined direction of the propulsion system and/or of the rolling object. Thus, the motion applied to the propulsion system and/or to the rolling object orients the lockable orientable off-centered wheel in the predetermined direction, and the automatic directional locking device locks this wheel in this direction.

According to an implementation of the invention, the frame can comprise at least two parts connected by a transverse-axis pivot connection and/or by a longitudinal slideway. Thus, the two parts of the frame can move relative to one another, either through rotation about a horizontal axis (transverse for example), or through translation, a longitudinal translation for example. Therefore, the two ends of the frame can move closer to or away from one another. Thus, the distance between the driven wheel and the lockable orientable off-centered wheel can be increased.

When the parts are connected through a rotation, the frame is foldable. This configuration allows to have the initially vertical axes of the orientable off-centered wheels oriented with a non-zero angle relative to the vertical direction. By being no longer vertical, the axes promote the orientation of the orientable off-centered wheels in the desired direction. Thus, the maneuverability of the system can be improved. Furthermore, the relative motion of the two parts of the frame can serve to orient the orientable off-centered wheels in the predetermined direction. Thus, the automatic directional locking device can be configured to lock at least one lockable orientable off-centered wheel through the relative motion of the two parts of the frame.

Preferably, at least one of the two parts of the frame can comprise at least one arm of variable length (also referred to as extensible arm) suited to control the distance between the at least one driven wheel and the at least one lockable orientable off-centered wheel, at least one lockable orientable off-centered wheel being positioned at one end of the arm of variable length.

According to one or more embodiments, the extensible arm can be, on the one hand, supported by at least one lockable orientable off-centered wheel and, on the other hand, connected to a non-motorized portion of the frame, the frame also comprising a motorized portion supporting the wheel driven by the electric machine.

According to one or more embodiments, the extensible arm can be substantially horizontal and it can have a main axis substantially parallel to the longitudinal direction of the frame. Thus, the arm of variable length can be advantageously positioned in the longitudinal direction. Thus, the distance between the driven wheel and the lockable orientable off-centered wheel can be increased, and this increase in distance increases the “5^{th} wheel” effect, thereby providing improved maneuverability of the system. Indeed, by increasing this distance, the pivot point thus generated is positioned as close as possible to the barycentre (the centre of gravity for example) of the assembly made up of the propulsion system coupled to the rolling object. This position of the pivot point allows to limit the space required for operating the assembly, notably for rotation and/or displacement of the coupled assembly in cramped rooms and/or corridors, when at least one orientable off-centered wheel is directionally locked.

According to one or more embodiments, the extensible arm can be moved relative to the non-motorized portion (along the axis parallel to the longitudinal direction of the frame) using an actuator such as a cylinder, itself connected to said extensible arm and to the non-motorized portion of the frame.

According to a variant of the invention, the two parts of the frame can be connected by an articulated structure in the central part of the frame, between the driven wheel and at least one lockable orientable off-centered wheel. The articulated structure both allows to use the relative rotational motion between the two parts of the frame for locking at least one lockable orientable off-centered wheel automatically, and to facilitate gripping and lifting of the rolling object wheels. Indeed, by enabling a rotational motion between the two parts of the frame, the gripping means can be lowered close to the ground level so as to facilitate gripping of the wheels of the rolling object, then, through a reverse rotational motion, to provide lifting of the wheels of the rolling object.

Preferably, the articulated structure can comprise, on the one hand, a first frame portion supported by the at least one motorized wheel and, on the other hand, a second frame portion supported by at least one lockable orientable off-centered wheel, preferably two lockable orientable off-centered wheels.

According to a variant of the invention, the frame portions can be articulated relative to one another around a horizontal rotation axis, for example substantially perpendicular to the longitudinal direction of the frame.

Preferably, at least one of the orientable off-centered wheels can comprise a braking means and/or a rotational locking means, serving as a parking brake for example. The braking means allows to slow the rotation of the orientable off-centered wheel about its horizontal rotation axis, thereby slowing down the system. The means providing rotational locking of the orientable off-centered wheel prevents rotation of the orientable off-centered wheel about its horizontal rotation axis. Thus, the rotational locking means can for example be engaged when the propulsion system is stopped so as to keep it stopped in a secure position.

The braking means and the rotational locking means can consist of a single device allowing both to brake the system (slow it down) and to keep it stopped.

The braking and rotational locking means can be of any type known to the person skilled in the art, a cable breaking means with a caliper clamped against the wheel for example. A parking brake can notably be used to prevent any inadvertent motion of the system, for example when the system, coupled or not, is positioned on a sloping plane, the braking means thus preventing the system from being driven down the slope.

The invention also relates to a coupled assembly comprising a rolling object and an electric propulsion system as described above, the rolling object being coupled to the electric propulsion system by the coupling means. Indeed, such a coupled assembly allows heavy and/or bulky rolling objects to be handled while limiting efforts and improving the maneuverability capacities of the assembly.

The invention further relates to a method for directionally locking at least one orientable off-centered wheel of an electric propulsion system as described above. In this method, the rolling object and/or the electric propulsion system is moved so as to position the (at least one) lockable orientable off-centered wheel in the predetermined direction, and this lockable orientable off-centered wheel is directionally locked in an automatic manner. Thus, the directional locking method is simple and requires no complex user intervention.

According to an embodiment of the method of the invention, a rotational and/or translational motion of at least one part of the frame in relation to the other part of the frame can be achieved, so as to position the (at least one) lockable orientable off-centered wheel in the predetermined direction, and (at least) this lockable orientable off-centered wheel is locked in an automatic manner. Indeed, using the connection between the two parts of the frame allows to orient the lockable orientable off-centered wheels in the predetermined direction and to move the lockable orientable off-centered wheels away from the driven wheel, thus improving the system maneuverability.

Advantageously, the length of the arm of variable length can be increased to the maximum position thereof so as to move the driven wheel away as far as possible from the lockable orientable off-centered wheel (or from the lockable orientable off-centered wheels, the system preferably comprising two such wheels). The length of the arm of variable length is then slightly decreased so as to position the lockable orientable off-centered wheel (or the lockable orientable off-centered wheels) in the opposite direction to the driven wheel. What is understood by slightly decreasing the length of the arm is to decrease it just enough to enable orientation of the orientable off-centered wheels in the opposite direction to the driven wheel. This sufficient decrease allows to orient the lockable orientable off-centered wheels in the opposite direction to the driven wheel, which allows the distance of the 5^{th} wheel effect to be increased to maximum. Indeed, by continuing to decrease the length of the arm, the 5^{th} wheel effect will be lessened because the distance between the driven wheel and the lockable orientable off-centered wheel is reduced. At least one of the lockable orientable off-centered wheels (preferably two such wheels) is then automatically locked in this direction. The length of the arm of variable length can for example be decreased until automatic directional locking occurs and reduction of the arm length can be stopped once directional locking obtained. Thus, the 5^{th} wheel effect is optimum. From this point, the length of the arms can again be increased so as to maximize the 5^{th} wheel effect.

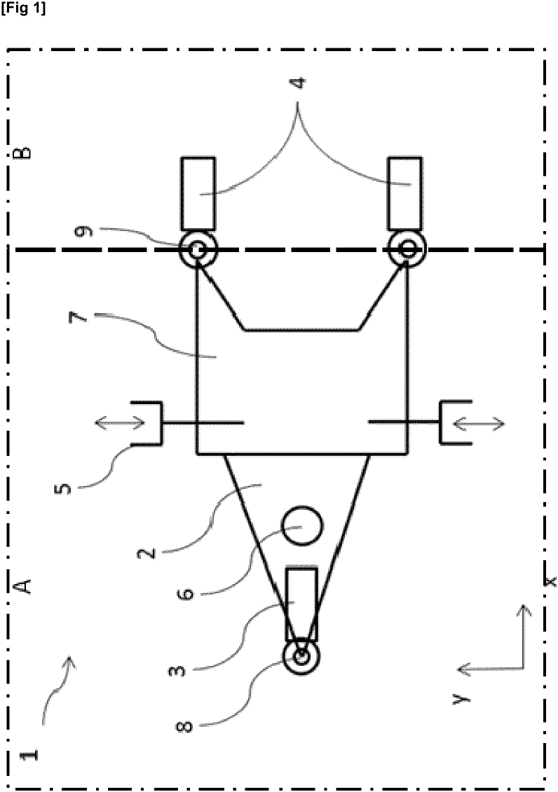

FIG. 1 schematically illustrates, by way of non-limitative example, an electric propulsion system 1 according to an embodiment of the invention. FIG. 1 is a top view of electric propulsion system 1. Electric propulsion system 1 comprises a frame 2. Axis x corresponds to the longitudinal axis of frame 2 and to the principal direction of displacement of propulsion system 1, and axis y corresponds to the lateral axis of frame 2 (axis z, not shown, is vertical). Frame 2 supports three wheels (alternatively, frame 2 can comprise four wheels). Frame 2 supports, at one longitudinal end thereof, a wheel 3 (alternatively, frame 2 can support two wheels 3), which is a wheel driven by an electric machine (not shown). Wheel 3 is orientable relative to frame 2, around a vertical axis 8. At the other longitudinal end of the frame, frame 2 supports two wheels 4, which are not driven by an electric machine. These two wheels 4 are off-centered wheels orientable around vertical axes 9. Electric propulsion system 1 further comprises coupling means 5.

Non-driven orientable off-centered wheels 4 can be directionally locked by an automatic directional locking device (not shown). This automatic directional locking device allows for example to lock the wheels when they are oriented in a predetermined direction, for example in the longitudinal direction here. In FIG. 1, orientable off-centered wheels 4 are oriented in an opposite direction to driven wheel 3 (on the opposite side to driven wheel 3) relative to vertical axes 9 of these orientable off-centered wheels 4. The top view of FIG. 1 is divided into two half-planes A and B. Half-plane A is on the left in FIG. 1 and half-plane B is on the right in FIG. 1. These two half-planes A and B are delimited and separated by the line connecting the two vertical axes 9 in top view. Driven wheel 3 is in half-plane A, to the left of the two vertical axes 9, whereas orientable off-centered wheels 4 are in half-plane B, to the right of vertical axes 9.

Orientable off-centered wheels 4, as shown in FIG. 1, are locked in a direction parallel to the longitudinal axis. In other words, in top view, the line formed, on the one hand, by the point representing each vertical axis 9 and, on the other hand, by the centre of the orientable off-centered wheel 4 associated with this vertical axis 9, is substantially longitudinal.

According to the embodiment illustrated, electric propulsion system 1 comprises two coupling means 5 on either side of the frame in the lateral direction (axis y) so as to provide coupling by means of two wheels of the rolling object (not shown). Coupling means 5 are shown in a simplified manner as clamps. The lateral motion of the coupling means is shown by a double arrow. This lateral motion can serve for gripping and orienting the wheels of the rolling object. Coupling means 5 are arranged, in direction x, between motorized wheel 3 and non-motorized wheels 4.

Furthermore, electric propulsion system 1 comprises a handlebar 6, for example in form of a rod equipped with a handle (not shown).

Besides, electric propulsion system 1 comprises a supporting platform 7 (for supporting a user for example). Platform 7 is arranged at the end of frame 2 supporting non-motorized wheels 4.

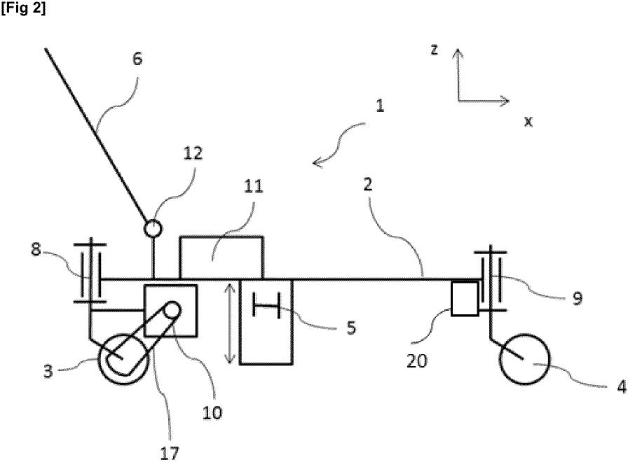

FIG. 2 schematically illustrates, by way of non-limitative example, an electric propulsion system 1 according to a first variant embodiment of the invention. FIG. 2 is a side view of electric propulsion system 1. Electric propulsion system 1 comprises a frame 2. Axis x corresponds to the longitudinal axis of frame 2 and to the principal direction of displacement of the propulsion system, and axis z corresponds to the vertical axis of frame 2, axis y (not shown) corresponding to the transverse axis. Frame 2 supports three wheels. Frame 2 supports a wheel 3, which is driven by an electric machine 10 by means of a drive 17, a belt or a chain for example (alternatively, electric machine 10 can be directly connected to wheel 3). Wheel 3 is orientable relative to frame 2, around a vertical axis 8. Electric machine 10 can be secured to pivot 8 of motorized wheel 3. At the other end, frame 2 supports two wheels 4, which are two wheels that are not driven by an electric machine. Wheels 4 are off-centered and orientable relative to frame 2 around vertical axes 9. Electric propulsion system 1 further comprises coupling means 5. According to the embodiment illustrated, electric propulsion system 1 comprises two coupling means 5, on either side of frame 2 in the lateral direction (axis y) so as to provide coupling by means of two wheels of the rolling object (not shown). Coupling means 5 are shown in a simplified manner as clamps. The vertical displacement of coupling means 5 is shown by a double arrow. This vertical displacement of the coupling means notably allows lifting of the rolling object wheels. Coupling means 5 are arranged, in direction x, between motorized wheel 3 and orientable off-centered wheels 4.

Orientable off-centered wheels 4, as shown in FIG. 2, are locked in the longitudinal direction x and in the opposite direction to driven wheel 3 relative to vertical axes 9 of these orientable off-centered wheels 4. An automatic directional locking device 20 enables directional locking of orientable off-centered wheels 4 in the longitudinal direction. This or these automatic directional locking device(s) 20 are connected, on the one hand, to frame 2 and, on the other hand, to each lockable orientable off-centered wheel 4. It provides directional locking of orientable off-centered wheels 4 around vertical axis 9 automatically when the orientable off-centered wheels are in the longitudinal direction and oriented in the opposite direction to driven wheel 3.

Furthermore, electric propulsion system 1 comprises a handlebar 6, for example in form of a rod equipped with a handle (not shown) connected to frame 2 by a joint 12.

Besides, electric propulsion system 1 comprises a battery 11. Battery 11 is arranged on frame 2 close to electric machine 10 and motorized wheel 3.

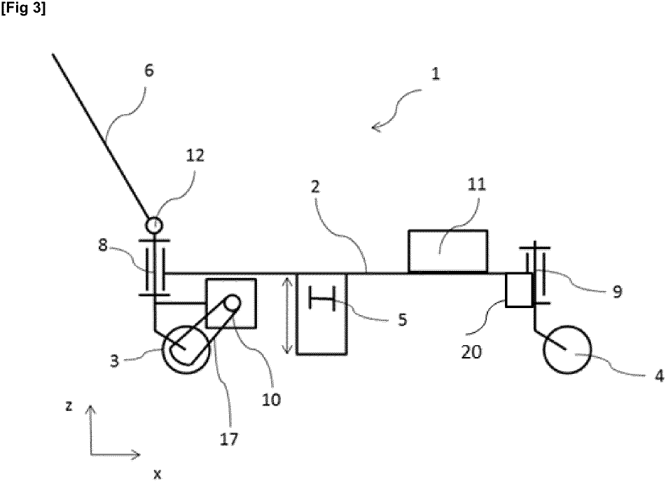

FIG. 3 schematically illustrates, by way of non-limitative example, an electric propulsion system 1 according to a second variant embodiment of the invention. FIG. 3 is a side view of electric propulsion system 1. Electric propulsion system 1 comprises a frame 2. Axis x corresponds to the longitudinal axis of frame 2 and to the principal direction of displacement of the propulsion system, and axis z corresponds to the vertical axis of frame 2. Frame 2 supports three wheels. Frame 2 supports a wheel 3, which is driven by an electric machine 10 by means of a drive 17, a belt or a chain for example. Wheel 3 is orientable relative to frame 2, around a vertical axis 8. Electric machine 10 can be secured to pivot 8 of motorized wheel 3. At the other end, frame 2 supports two wheels 4, which are two wheels that are not driven by an electric machine. Wheels 4 are off-centered and orientable relative to the frame around vertical axes 9.

The two orientable off-centered wheels 4 can be locked in a predetermined direction around their vertical axis 9, by means of automatic directional locking device 20. This or these automatic directional locking device(s) 20 are connected, on the one hand, to frame 2 and, on the other hand, to each of the two orientable off-centered wheels 4. Each orientable off-centered wheel 4 is positioned in the longitudinal direction and opposite to driven wheel 3.

Electric propulsion system 1 further comprises coupling means 5. According to the embodiment illustrated, electric propulsion system 1 comprises two coupling means 5, on either side of the frame in the lateral direction (axis y) so as to provide coupling by means of two wheels of the rolling object (not shown). Coupling means 5 are shown in a simplified manner as clamps. The vertical motion of coupling means 5 is shown by a double arrow. This vertical motion of the coupling means notably allows lifting of the rolling object wheels. Coupling means 5 are arranged, in direction x, between motorized wheel 3 and orientable off-centered wheels 4.

Furthermore, electric propulsion system 1 comprises a handlebar 6, for example in form of a rod equipped with a handle (not shown) connected to vertical-orientation axis 8 of motorized wheel 3 by a joint 12.

Besides, electric propulsion system 1 comprises a battery 11. Battery 11 is arranged on frame 2 close to non-motorized wheels 4.

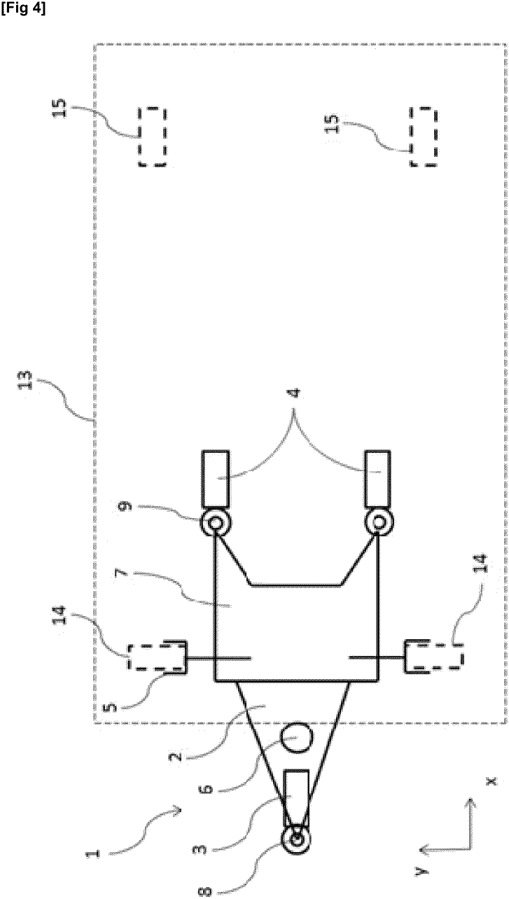

FIG. 4 schematically illustrates, by way of non-limitative example, an electric propulsion system 1 according to an embodiment of the invention, coupled to a rolling object 13. FIG. 4 is a top view of electric propulsion system 1 and of rolling object 13. The embodiment of FIG. 4 corresponds to the embodiment of FIG. 1. Rolling object 13 can be of any type, notably a rolling bed. The rolling object comprises two wheels 14, arbitrarily referred to as rear wheels, and two wheels 15, arbitrarily referred to as front wheels. Electric propulsion system 1 comprises a frame 2. Axis x corresponds to the longitudinal axis of frame 2 and to the principal direction of displacement of the propulsion system, and axis y corresponds to the lateral axis of frame 2. The frame supports three wheels. Frame 2 supports a wheel 3, which is a wheel driven by an electric machine (not shown). Wheel 3 is orientable with respect to frame 2, around a vertical axis 8. At the other end, frame 2 supports two wheels 4, which are two wheels that are not driven by an electric machine. Wheels 4 are off-centered and orientable with respect to the frame around vertical axes 9. These orientable off-centered wheels 4 can be directionally locked in an automatic manner by an automatic directional locking device (not shown).

Electric propulsion system 1 further comprises coupling means 5. According to the embodiment illustrated, electric propulsion system 1 comprises two coupling means 5 on either side of the frame in the lateral direction (axis y) in order to achieve coupling by means of two rear wheels 14 of the rolling object. Coupling means 5 are shown in a simplified manner as clamps. Rear wheels 14 of the rolling object are arranged in the clamps, and they are substantially oriented along axis y, i.e. an axis perpendicular to the longitudinal axis (axis x) of frame 2. Furthermore, front wheels 15 of the rolling object are free and not coupled.

Electric propulsion system 1 also comprises a handlebar 6, for example in form of a rod equipped with a handle (not shown) articulated relative to frame 2.

Besides, electric propulsion system 1 comprises a supporting platform 7 (for supporting a user for example). Platform 7 is arranged at the end of frame 2 supporting non-motorized wheels 4. For the embodiment of FIG. 4, coupling means 5, non-motorized wheels 4, platform 7 and a major part of frame 2 are located beneath the rolling object. Only motorized wheel 3 and handlebar 6 can protrude from rolling object 13 in the longitudinal direction x of frame 2.

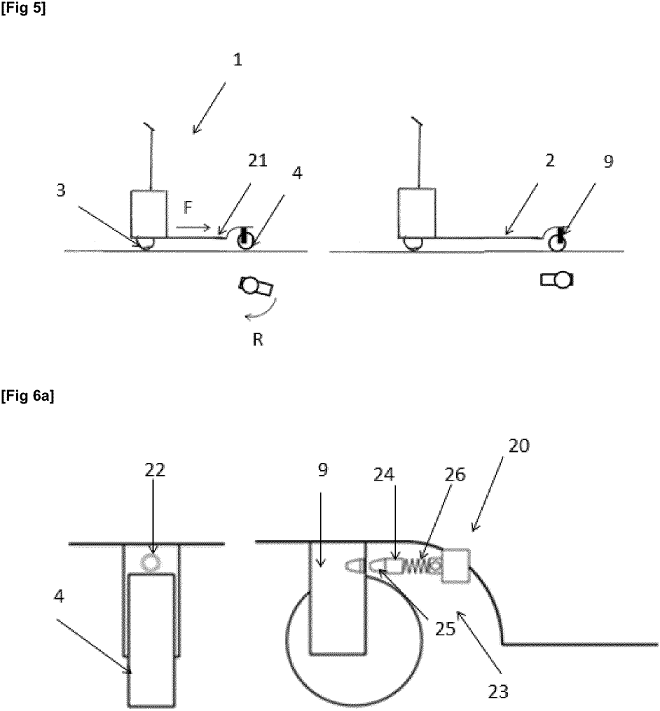

FIG. 5 schematically illustrates, by way of non-limitative example, steps of a first method for locking orientable off-centered wheels in a predetermined direction. In this figure, the lower part shows the position of the orientable off-centered wheel in top view.

In the figure, propulsion system 1 comprises a frame 2 in two parts. One of the parts, referred to as first part, has an arm 21 of variable length. The other part, referred to as second part, supports a wheel 3 driven by an electric machine (not shown). The first part supports two orientable off-centered wheels 4 that can be directionally locked around vertical axis 9.

Alternatively, the system can comprise several arms of variable length, and each arm of variable length can comprise one or more orientable off-centered wheels, without departing from the scope of the invention.

The diagram on the left shows the arm of variable length 21 being extended as shown by arrow F. Orientable off-centered wheels 4 are initially in an opposite direction to the direction of driven wheel 3 relative to their vertical axis 9. In side view, vertical axes 9 of orientable off-centered wheels 4 are between the centre of each orientable off-centered wheel 4 and the centre of driven wheel 3. During extension of arm 21 of variable length, the orientable off-centered wheels tend to be oriented in the opposite direction to the motion of the arm of variable length. They therefore rotate about their vertical axes 9 in a rotation R or the opposite rotation to R. They are then steered towards driven wheel 3 as shown in the diagram on the right when the arm of variable length follows the stroke of the cylinder, for example to reach the maximum extension thereof. In side view, the centres of each orientable off-centered wheel 4 are then between the centre of driven wheel 3 and their vertical axes 9.

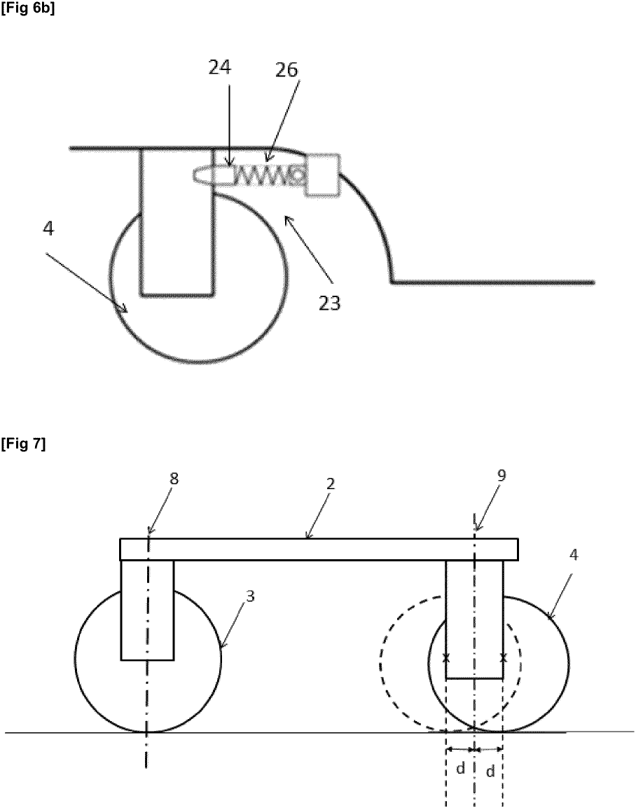

FIG. 6a schematically shows, by way of non-limitative example, a first embodiment of an automatic directional locking device 20 according to the invention.

In this figure, orientable off-centered wheel 4 can freely rotate about its vertical axis 9. Orientable off-centered wheel 4 is a lockable orientable off-centered wheel. It therefore comprises a first connecting element 22, here a female element materialized by an orifice comprising a cylindrical part.

Vertical axis 9 of orientable off-centered wheel is connected to the frame of the propulsion system according to the invention. A second connecting element 23 capable of cooperating with first connecting element 22 so as to lock orientable off-centered wheel 4 in a predetermined direction is positioned on this frame 2. This second connecting element 23 is here a male element comprising a pin 24. The diameter of pin 24 is smaller than the diameter of the orifice of female element 22 of orientable off-centered wheel 4, so as to allow insertion of male element 23 into female element 22. Pin 24 has a conical part 25 so as to facilitate insertion of male element 23 into female element 22.

Besides, in order to enable automatic directional locking of orientable off-centered wheels 4, pin 24 is armed by a spring 26. When orientable off-centered wheel 4 is not in the predetermined direction, the orifice of female element 22 is not opposite male element 23. Spring 26 is then compressed: it is armed, ready to engage pin 24 into female element 22. When orientable off-centered wheel 4 is oriented in the predetermined direction, the orifice of female element 22 is then opposite male element 23. Spring 26 then decompresses and drives pin 24 of male element 23 into female element 22, thereby causing automatic directional locking of orientable off-centered wheel 4.

FIG. 6b illustrates pin 24 of male element 23 engaged in the female element, once orientable off-centered wheel 4 is positioned in the predetermined direction enabling automatic locking. Spring 26 is then released.

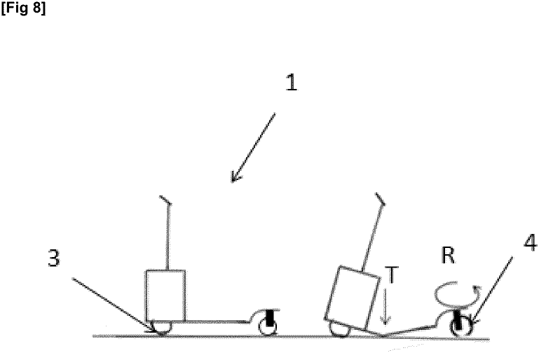

FIG. 7 illustrates the relative position of an orientable off-centered wheel 4 in a (first) direction in solid line and, in the opposite direction (forming an angle of 180° with respect to the first direction), in dotted line. Orientable off-centered wheel 4 is naturally oriented around its vertical axis 9, which serves as rotation axis for orienting the orientable off-centered wheel, according to the direction of travel of the propulsion system. This natural orientation is due to the misalignment d between vertical axis 9 and the centre of orientable off-centered wheel 4.

Orientable off-centered wheel 4 and driven wheel 3 are connected to frame 2. Driven wheel 3 is not an orientable off-centered wheel. Indeed, its vertical axis 8 passes through the centre of driven wheel 3. Alternatively, wheel 3 can be an orientable off-centered wheel.

In this example embodiment, the distance between vertical axis 8 and vertical axis 9 is fixed.

Depending on the orientation of orientable off-centered wheel 4, the distance between the axes of lockable orientable off-centered wheels 4 and of driven wheel 3 can be modified. Indeed, when orientable off-centered wheel 4 is locked in the second direction, i.e. in the direction of the driven wheel, the distance between the centres of the two wheels (of driven wheel 3 and of orientable off-centered wheel 4) corresponds to the distance between vertical axes 8 and 9, diminished by misalignment d.

On the contrary, when orientable off-centered wheel 4 is locked in the first direction, i.e. in the opposite direction to the driven wheel, vertical axis 9 being located between the centre of driven wheel 3 and the centre of orientable off-centered wheel 4 in side view, the distance between the centres of the two wheels (driven wheel 3 and orientable off-centered wheel 4) corresponds to the distance between vertical axes 8 and 9, increased by misalignment d.

In other words, when the wheel is locked in the first direction (wheel oriented in the opposite direction to driven wheel 3 relative to vertical axis 9), the distance between the centres of driven wheel and orientable off-centered wheel 4 is maximum. When it is desired to maximize the maneuverability capacities, notably in very reduced spaces, increasing the distance between the centres of driven wheel 3 and orientable off-centered wheel 4 allows to move the pivot point away and to position it as close as possible to the centre of the coupled assembly, thereby gaining maneuverability.

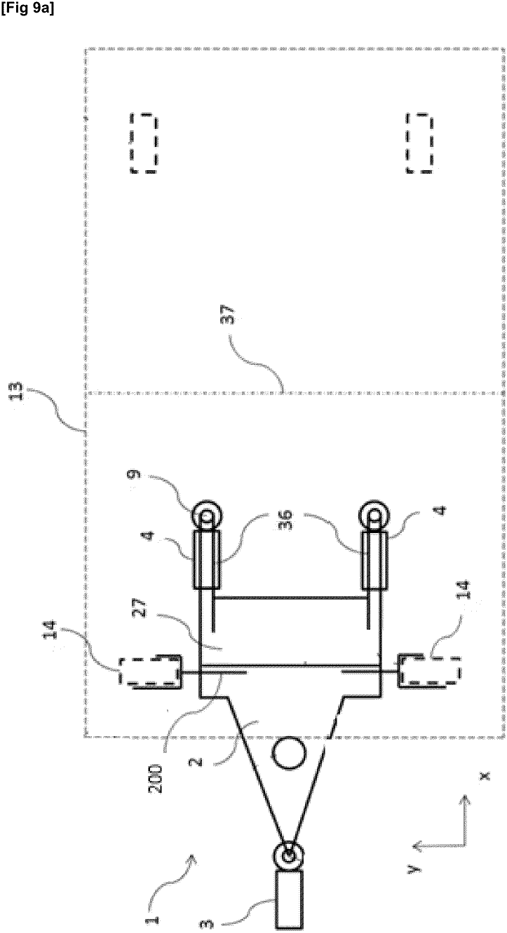

FIG. 8 schematically shows, by way of non-limitative example, steps of a second method for orienting orientable off-centered wheel 4 in the predetermined direction enabling directional locking of orientable off-centered wheel 4.

Propulsion system 1 comprises a frame with a driven wheel 3 and two orientable off-centered wheels 4. The frame comprises an articulated structure connecting at least two parts of the frame. During articulation of the articulated structure of the frame, for example through a downward motion T of the articulated structure, the misalignment of orientable off-centered wheel 4 generates the orientation of orientable off-centered wheel 4 around its off-centered pivot axis that is no longer vertical here. This inclination of the axis relative to the vertical axis allows to cause rotation of the wheel so as to orient it in the opposite direction to driven wheel 3. Thus, a motion generated on the articulated structure of the frame can be used to orient orientable off-centered wheel 4 in the predetermined direction. An automatic directional locking device can then lock the wheel directionally.

It is seen in FIG. 8 that wheel 4 is initially oriented in the direction of driven wheel 3 in the left-hand diagram. Due to the downward motion T causing folding of the two parts of the frame, orientable off-centered wheel 4 pivots around its vertical (initially vertical) axis to be oriented in the opposite direction to driven wheel 3.

When the system also comprises a longitudinal slideway, orientable off-centered wheels 4 can then be moved away from driven wheel 3 so as to be positioned as close as possible to the centre of the rolling object.

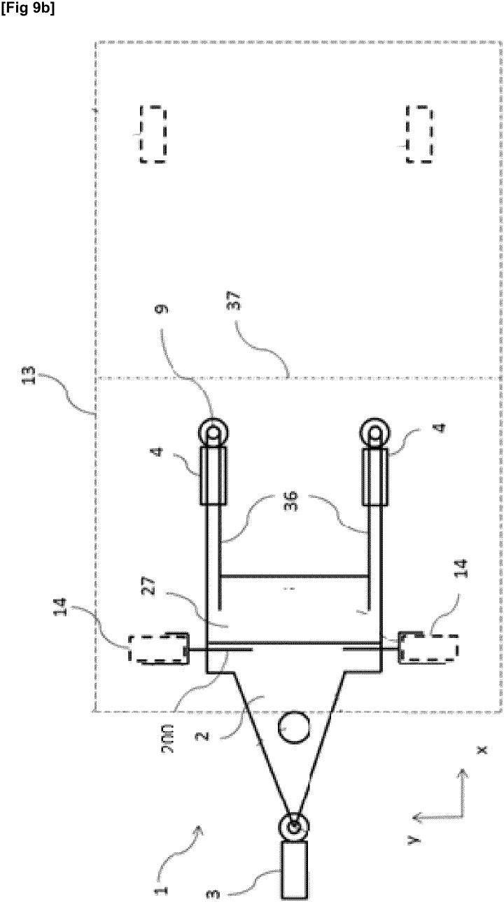

FIGS. 9a and 9b schematically illustrate, by way of non-limitative example, one or more embodiments suited to assist the user in handling the coupled assembly and comprising two extensible arms 36 positioned on frame 2, allowing to modify the distance between the at least one orientable off-centered wheel 4 and driven wheel 3 (and the distance between orientable off-centered wheel 4 and means 200 for gripping and lifting wheels 14 of rolling object 13). Each extensible arm 36 is, on the one hand, supported by an orientable off-centered wheel 4 through vertical axis 9 and, on the other hand, connected to the non-motorized portion 27 of the frame. Advantageously, extensible arms 36 allow orientable off-centered wheels 4 to be positioned as close as possible to central part 37 of the rolling object (in the longitudinal direction of the frame). This provides increased maneuverability, known as “5^{th} wheel effect”, notably upon rotation and/or displacement of the coupled assembly in cramped rooms and/or corridors, in particular when the directional motion of said orientable off-centered wheel 4 is locked. In connection with FIG. 9a, extensible arms 36 are in a retracted position. In connection with FIG. 9b, the actuator(s) is (are) operated so as to lengthen extensible arms 36 and to increase the distance between orientable off-centered wheels 4 and driven wheel 3 (and the distance between orientable off-centered wheels 4 and means 200 for gripping and lifting wheels 14 of rolling object 13).

1. A removable electric propulsion system (1) for a rolling object (3), said propulsion system (1) comprising a frame (2) provided with at least one wheel (3) driven by an electric machine (10), and at least one non-driven wheel (4), at least one of said at least one non-driven wheel (4) comprising an orientable off-centered wheel, said electric propulsion system (1) comprising means (5) for coupling said electric propulsion system (1) to said rolling object (13), said coupling means (5) comprising means (200) for gripping and lifting at least one wheel (14) of said rolling object (13), characterized in that electric propulsion system (1) comprises an automatic directional locking device (20) for locking, in a predetermined direction, the rotation about a vertical axis (9) of at least one of said orientable off-centered wheels (4), preferably the predetermined direction being along the longitudinal axis of frame (2), the longitudinal axis (x) being defined by the principal direction of displacement of frame (2).

2. A removable electric propulsion system (1) as claimed in claim 1, wherein automatic directional locking device (20) locks at least one of said lockable orientable off-centered wheels in the direction of driven wheel (3).

3. A removable electric propulsion system (1) as claimed in claim 1, wherein automatic directional locking device (20) locks at least one of said lockable orientable off-centered wheels in the opposite direction to driven wheel (3).

4. A removable electric propulsion system (1) as claimed in claim 1, wherein electric propulsion system (1) comprises at least two lockable orientable off-centered wheels, automatic directional locking device (20) locking said at least two lockable orientable off-centered wheels in said predetermined direction.

5. A removable electric propulsion system (1) as claimed in claim 1, wherein said coupling means (5) comprise means for orienting at least one wheel of said rolling object in a direction forming a non-zero angle with longitudinal direction (x) of said frame (2) of said electric propulsion system (1), preferably said coupling means (5) comprise means for orienting at least one wheel of said rolling object in a direction substantially perpendicular to longitudinal direction (x) of said frame (2) of said electric propulsion system (1).

6. A removable electric propulsion system (1) as claimed in claim 1, wherein said automatic directional locking device (20) comprises at least two connecting elements (22, 23) configured to cooperate with one another so as to provide directional locking, a first connecting element being positioned on at least one of said lockable orientable off-centered wheels and a second connecting element being positioned on said frame, preferably one of said two connecting elements is a male element (23) and the other of said two connecting elements is a female element (22), the engagement of said male element in said female element providing said directional locking.

7. A removable electric propulsion system (1) as claimed in claim 6, wherein automatic directional locking device (20) comprises at least two female elements (22) and/or at least two male elements (23).

8. A removable electric propulsion system (1) as claimed in claim 6, wherein said male elements (23) comprise at least one pin (24), one finger and/or one key.

9. A removable electric propulsion system (1) as claimed in claim 6, wherein said female elements (22) comprise cylindrical holes, oblong holes and/or grooves.

10. A removable electric propulsion system (1) as claimed in claim 1, wherein said automatic directional locking device (20) comprises an unlocking control means, said unlocking control means preferably comprising an electromagnet, the unlocking control means being preferably manual.

11. A removable electric propulsion system (1) as claimed in claim 1, wherein automatic directional locking device (20) locks at least one of said lockable orientable off-centered wheels through the motion opposite to said predetermined direction of electric propulsion system (1) and/or of rolling object (13).

12. A removable electric propulsion system (1) as claimed in claim 1, wherein frame (2) comprises at least two parts connected by a transverse-axis pivot connection and/or by a longitudinal slideway, said automatic directional locking device (20) being configured to lock at least one of said lockable orientable off-centered wheels through the relative motion of said two parts.

13. A removable electric propulsion system (1) as claimed in claim 12, wherein at least one of said two parts comprises at least one arm of variable length (36), at least one of said lockable orientable off-centered wheels being positioned substantially at one end of said arm of variable length (36).

14. A removable electric propulsion system (1) as claimed in claim 13, wherein said two parts are connected by an articulated structure in the central part of frame (2), between at least one of driven wheels (3) and at least one of said orientable off-centered wheels (4).

15. A coupled assembly comprising a rolling object (13) and an electric propulsion system (1) as claimed in claim 1, said rolling object (13) being coupled to said electric propulsion system (1) by said coupling means (5).

16. A method for directional locking of at least one of said lockable orientable off-centered wheels of a removable electric propulsion system (1) as claimed in claim 1, wherein rolling object (13) and/or electric propulsion system (1) is moved so as to position at least one of said lockable orientable off-centered wheels in said predetermined position, and at least one of said lockable orientable off-centered wheels is directionally locked in an automatic manner.

17. A method for directional locking of at least one of said lockable orientable off-centered wheels of a removable electric propulsion system (1) as claimed in claim 12, wherein a rotational and/or translational motion of at least one part of frame (2) in relation to the other part of frame (2) is achieved, so as to position at least one of said lockable orientable off-centered wheels in said predetermined position, and at least one of said lockable orientable off-centered wheels is directionally locked in an automatic manner.

18. A method for directional locking of at least one of said lockable orientable off-centered wheels of a removable electric propulsion system (1) as claimed in claim 13, wherein the length of said arm of variable length (36) is increased to its maximum position, then the length of said arm of variable length (36) is decreased so as to position at least one of said lockable orientable off-centered wheels in the opposite direction to driven wheel (3), and at least one of said lockable orientable off-centered wheels is automatically locked in said opposite direction to driven wheel (3).
